(19) United States
(12) Patent Application Publication
(10) Pub. No.: US 2011/0199937 A1
(43) Pub. Date: Aug. 18, 2011

(54) METHOD FOR CONFIGURING A WIRELESS NETWORK

(76) Inventors: Christophe Demarez, Igny (FR); Philippe Godin, Viroflay (FR)

(21) Appl. No.: 13/001,822

(22) PCT Filed: Jun. 30, 2009
(86) PCT No.: PCT/EP2009/004693

§ 371 Date: Apr. 4, 2011

(30) Foreign Application Priority Data
Jun. 30, 2008 (EP) 08290637.1

(51) Int. Cl. H04L 12/28

(52) U.S. Cl. 370/254

(57) ABSTRACT

A method for configuring a wireless network having a plurality of nodes to which a mobile device attaches to access the network, a plurality of gateways (GTW) and a mobile management entity (MME), includes the steps of: each GTW providing to the MME a code giving its identity and information identifying the nodes that the respective GTW serves; and the MME sending the code and information identifying the nodes that the respective GTW serves to nodes of the network at which the code and information is stored. The plurality of nodes may include home nodes. The network may be, for example, an LTE network.

### FIELD OF THE INVENTION

The present invention relates to a method for configuring a wireless network, and more particularly, but not exclusively, to a network having a plurality of home base stations.

### BACKGROUND

Currently, the 3rd Generation Partnership Project (3GPP) is developing Long Term Evolution (LTE), also referred to as E-UTRAN, as set out in the technical specification 3GPP TS 36.300 v 8.5.0 (2008-05), to which the reader is referred for additional information, and related documents. 3GPP LTE aims to enhance the Universal Mobile Telecommunications System (UMTS) Radio Access Network standard, for example, by improving efficiency and services.

In LTE, user equipment (UE) communicates with a network node, E-UTRAN NodeB (eNB), with data being sent on radio bearers (RBs) over a radio link between them. The eNB interfaces with a Mobile Management Entity (MME) via an interface designated as S1. An LTE network typically includes a plurality of eNBs and MMEs as illustrated schematically in FIG. 1 which gives an overview of a network. The eNBs are interconnected with each other by the X2 interface. The eNBs are also connected by means of the S1 interface to the EPC (Evolved Packet Core), more specifically to the MME (Mobility Management Entity) by means of the S1-MME and to the Serving Gateway (S-GW) by means of the S1-U. The S1 interface supports a many-to-many relation between MMEs/Serving Gateways and eNBs. S1-flex mechanisms allow an eNB to be connected to a plurality of MMEs.

In LTE, the routing of S1 handover messages is based on the target eNB id when the target eNB is a macro eNB, that is, the MME routes the handover message from source eNB to the correct target eNB based on the target eNB id received in the Handover Required message over S1.

However, when the target eNB is a home eNB, a pool area will potentially contain several hundreds thousands of home eNBs. Thus, the MIME would need a routing table with several hundreds thousands entries. To avoid this, in one proposal for S1 handovers towards home eNBs, the MME routes towards the home eNB Gateway (GTW) relevant to the home eNB instead of to the home eNB itself. This GTW then further routes the message towards the correct destination home eNB. Therefore, the source eNB must include the target GTW-id in the handover message to the MME instead of the target home eNB id.

As part of the LTE-UMTS automatic neighbor relation function (ANRF), the eNB to which an UE is attached may be informed by the UE that it has detected a new neighboring cell. However, whenever a new neighbor home eNB cell is detected as part of the ANRF Self Optimizing Network (SON) function, the UE will only report to the source eNB the global cell id and the Tracking Area Code (TAC) broadcast by that neighbor home eNB cell. The source eNB cannot determine from this report which is the relevant GTW-id to which to route the handover message.

One proposal involves changing the routing principle. It has been proposed to include the TAC of the neighbor cell in the Handover message. Then the MME bases the routing of the handover message on this received TAC instead of basing it on the Target eNB id field. With this proposal, the MME uses a different mechanism for routing handover messages towards home eNBs compared to the routing of handover messages towards macro eNBs. Thus, two different routing mechanisms would have to co-exist in the MIME. In one approach, the handover message has a different content for the home eNB case, by including an additional TAC in it, compared to the handover message for routing to a macro cell. Alternatively, all handover messages include the TAC information, but the MME cannot discriminate whether to route based on the TAC information (home eNB target) or based on the target eNB-id information (classical macro eNB target).

### BRIEF SUMMARY

According to an aspect of the invention, a method for configuring a wireless network having a plurality of nodes to which a mobile device attaches to access the network, a plurality of gateways (GTW) and a mobile management entity (MME), includes the steps of: each GTW providing to the MME a code giving its identity and information identifying the nodes that the respective GTW serves; and the MME sending the code and information identifying the nodes that the respective GTW serves to nodes of the network at which the code and information is stored. It is particularly applicable to networks including home base stations, such as those used in domestic settings and business premises and the like. Although it is envisaged that the method is particularly suited to networks in accordance with LTE standards, it may also be applied to networks of other radio technology types.

By employing a method in accordance with the invention in an LTE network, for example, a routing mechanism in the MME based on the id of the destination node of the routing may be used for both the macro and home eNB case. Use of a method in accordance with the invention allows MIME routing principles to remain unmodified, even where home eNBs are involved, thus simplifying the MME and minimizing development effort.

A method in accordance with the invention may allow a SON solution for the S1 handovers in the context of home eNBs that is fully automated requiring no manual configuration effort.

As soon as one new neighbour home eNB cell is detected and reported to a source eNB by a UE, the source eNB is already self-configured to be able to perform S1 handovers towards that neighbor home eNB cell.

Existing S1AP messages may be used to transmit the information by simply adding some new Information Elements to them.

The signalling could be limited to a couple of TAs.

It also enables the functionality of the MME to be independent of the presence or not of an optionally deployed gateway.

Also, a routing table in the MME (which is based on GTW-id) need not be not modified whenever the TAC configuration changes within the home eNB Gateway serving area.

### BRIEF DESCRIPTION OF THE DRAWINGS

Some methods and embodiments in accordance with the present invention will now be described, by way of example only, and with reference to the accompanying drawings, in which:

FIG. 1 schematically illustrates a wireless LTE network;

FIG. 2 schematically illustrates messaging between a GTW and MME; and

FIG. 3 schematically illustrates messaging between an MME and eNB.

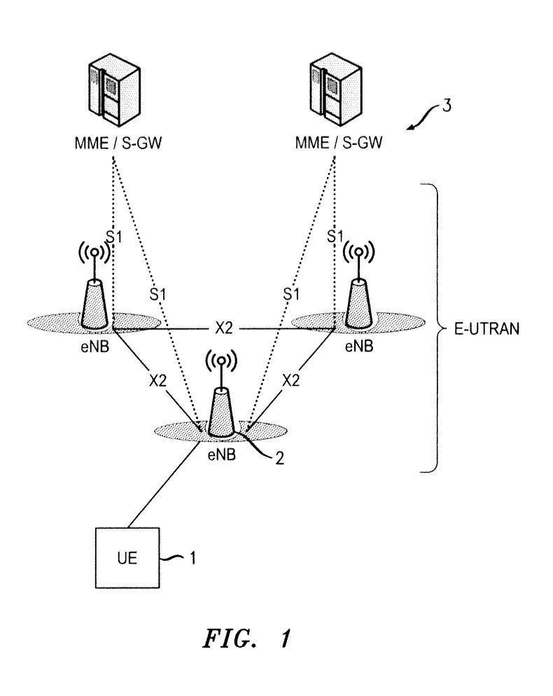

### DETAILED DESCRIPTION

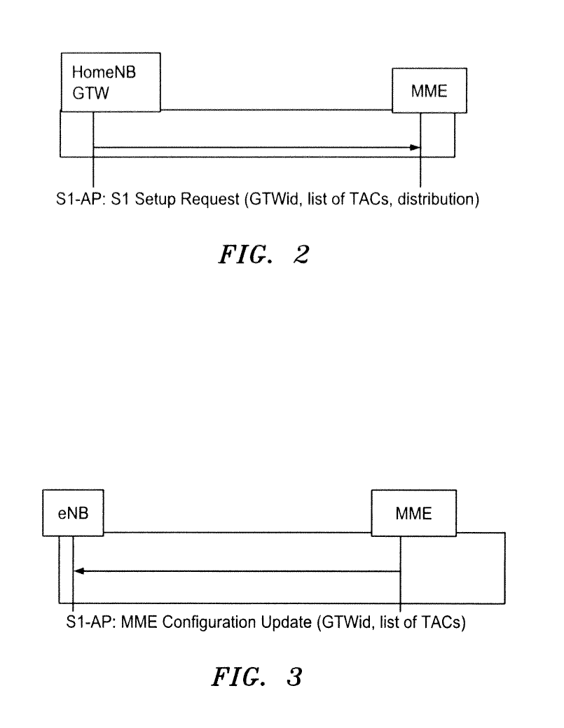

With reference to FIGS. 2 and 3, each home eNB GTW provides to the MME, in an initial S1 Setup Request message, its GTW identity together with the list of Tracking Area Codes (TACs) of the home eNBs it serves. It can also include a list of distribution TAs as to where to distribute the information, which it knows for handovers from home eNB towards macro eNB. The MME sends the GTW identity and the associated list of TACs to all eNBs belonging to the list of distribution TAs, the list comprising at least the TAs the GTW serves plus a list of neighboring TAs, or, to a maximum extent, to all TAs of the pool area. Each eNB receiving the information stores this information.

Whenever a new detected neighbor home eNB cell identity is reported to the eNB together with its TAC, the eNB looks up in the stored information to derive what is the GTW id corresponding to that TAC,

The eNB builds up a regular handover message which includes the GTW id in the target eNB id field as destination for routing the handover message. The MME routes based on the target eNB id. It is sufficient that one MME only is involved in the distribution process. It may be randomly selected by the GTW or default configured. The distribution of information could be limited to eNBs of neighboring TAs and would not need to be pool area wide

In FIG. 2, a home eNB GTW sends when it is set in operation in the S1 Setup Request message the list of TACs of all the home eNBs it serves and possibly a list of distribution TAs.

With reference to FIG. 3, the MME sends a MEME Configuration update message or any other configuration-oriented message containing a list of one or several home eNB GTW-ids and for each home eNB GTW-id one list of associated TACs.

Any change in the list of TACs supported by a gateway could be propagated in a similar manner.

The present invention may be embodied in other specific forms and implemented using other methods without departing from its spirit or essential characteristics. The described embodiments and methods are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for configuring a wireless network having a plurality of nodes to which a mobile device attaches to access the network, a plurality of gateways (GTW) and a mobile management entity (MME), including the steps of:
each GTW providing to the MME a code giving its identity and information identifying the nodes that the respective GTW serves; and
the MME sending the code and information identifying the nodes that the respective GTW serves to nodes of the network at which the code and information is stored.

2. The method as claimed in claim 1 wherein the plurality of nodes includes home nodes.

3. The method as claimed in claim 1 wherein when a new neighboring cell is detected by a mobile device attached to a source node, the cell identity of the new neighboring cell is reported to the source node together with information identifying which GTW it is served by, and the source node derives the code for the GTW using the stored information.

4. The method as claimed in claim 1, wherein the network is in accordance with LTE standards and the nodes are eNBs.

5. The method as claimed in claim 4 wherein the information identifying the nodes that the respective GTW serves is a list of Tracking Area Codes (TACs) of the eNBs the GTW serves.

6. The method as claimed in claim 5 wherein the GTW provides a list of distribution Tracking Areas (TAs) giving where the information is to be distributed.

7. The method as claimed in claim 6 wherein the list of distribution TAs includes the TAs the GTW serves and neighboring TAs served by other GTW.

8. The method as claimed in claim 1 wherein a handover message includes the GTW identity code in the target identification field as the destination for routing the message.

9. The method as claimed in claim 1 wherein a wireless network is arranged to implement the method.
